(19) United States
(12) Patent Application Publication
(10) Pub. No.: US 2024/0246047 A1
(43) Pub. Date: Jul. 25, 2024

(54) Airborne Dust Mitigation System

(71) Applicant: Refractory Construction Services Co. LLC, Deer Park, TX (US)

(72) Inventors: Christopher P. Lanclos, Deer Park, TX (US); Hunter Whatley, Deer Park, TX (US)

(21) Appl. No.: 18/158,167

(22) Filed: Jan. 23, 2023

(51) Int. Cl. B01F 35/00; B01F 33/502; B04C 3/00; B04C 9/00; B08B 15/02

(52) U.S. Cl. CPC B01F 35/187; B01F 33/5023; B04C 3/00; B04C 9/00; B08B 15/02; B01F 2101/28; B04C 2009/002

(57) ABSTRACT

A system for use with a gunite rig to capture airborne gunite type materials, particularly those containing silica, during the preparation of the gunite. In one respect, as the bags of silica-containing material are placed in the mixing section of the gunite rig and ripped open, airborne gunite dust is captured by a hood, separation, and suction system positioned above the mixer. The mitigation system also includes a plenum box and suction system positioned adjacent the mouth of a gunite pot to capture gunite dust generated as the mixed gunite material falls from a hopper into the gunite pot. A separator positioned upstream of a dust collection apparatus separates the larger heavier particles from the lighter ones.

### FIELD OF THE INVENTION

The present invention relates to the mitigation of airborne dust and, more particularly, to silica dust generated in the preparation of silica-containing refractory compositions used in forming heat refractory surfaces, e.g., to the insides of vessels such as reactors, crackers, furnaces, etc.

### BACKGROUND OF THE INVENTION

Reaction vessels, catalytic crackers, furnaces, and like vessels are commonly lined with a refractory material because of the high temperatures which can occur in the vessels. In particular, once such refractory lining commonly used contains silica powder which is considered by the Occupational Safety and Health Administration (OSHA) to be quite harmful when inhaled. Accordingly, in operations where a silica-containing refractory material is being prepared for use in lining a vessel, precautions must be taken to reduce the amount of airborne silica dust.

A typical trailer mounted rig (gunite rig) for preparing a silica-containing refractory material comprises a mixing chamber for mixing and wetting the ingredients of the gunite/shortcrete material (gunite), and a conveyor for transferring the mixed gunite material to a hopper, the hopper having bottom gates which are manually opened as needed to discharge a fixed amount of gunite material into a pressurized gunite pot, the gunite pot being connected to a hose which in turn is connected to a nozzle for applying the mixed gunite to the walls of the vessel to be lined.

There are two steps which occur on the gunite rig which can generate significant amounts of airborne solids, e.g., silica dust. The mixer is generally an open box-like structure having a grate under which is rotatably mounted a paddle mixer. A serrated cutter is mounted in the mixer and extends above the grate. Sacks of the silica-containing gunite are manually dumped on the grate, the bags being cut open by the cutter. The gunite is mixed with water to form a flowable, wetted gunite. In this step, when the bags are being cut open, a significant amount of airborne dust containing silica is released. As a safety precaution, the worker is equipped with a mask or other such equipment to alleviate inhalation of the airborne dust. Nonetheless, using prior art systems a significant amount of airborne dust is released from the mixer into the atmosphere. This release of airborne silica dust to the atmosphere is partially mitigated by the fact that the trailered rig, and the workers operating the rig, are in a temporary enclosure which is under some suction to recover the airborne dust in the enclosure. However, it would clearly be advantageous to keep the airborne dust generated when the bags are opened from entering the enclosure in the first place.

The second dust generating step which occurs on the gunite rig is when the mixed/wetted gunite is released from the hopper into the pot to which the gunite nozzles are attached. Again, in this step a significant amount of airborne dust (silica) can escape into the enclosure.

### SUMMARY OF THE INVENTION

In one aspect, the present invention relates to the mitigation of airborne dust generated in gunite and shortcrete generation operations.

In another aspect, the present invention relates to the mitigation of airborne silica dust present in gunite/shortcrete materials used to form refractory walls on vessels.

In a further aspect, the present invention relates to a system for mitigating the dispersion into the atmosphere of silica-containing dust, capturing it at its point of generation.

In still a further aspect, the present invention relates to a system for mitigating the dispersion of silica-containing dust into the atmosphere which can be retrofitted to existing gunite rigs.

These and further features and advantages of the present invention will become apparent from the following detailed description, wherein reference is made to the figures in the accompanying drawings.

### BRIEF DESCRIPTION OF THE DRAWINGS

FIG. 1 is a perspective view of a prior art gunite rig.

FIG. 2 is a perspective view of a gunite rig in accordance with one embodiment of the present invention.

FIG. 3 is a perspective view of one portion of the gunite rig depicted in FIG. 2.

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements. The various embodiments of the invention may however, be embodied in many different forms and should not be construed as limited to the embodiments set forth herein. Rather, these embodiments are provided so that this disclosure will be thorough and complete, and will fully convey the scope of the invention to those skilled in the art.

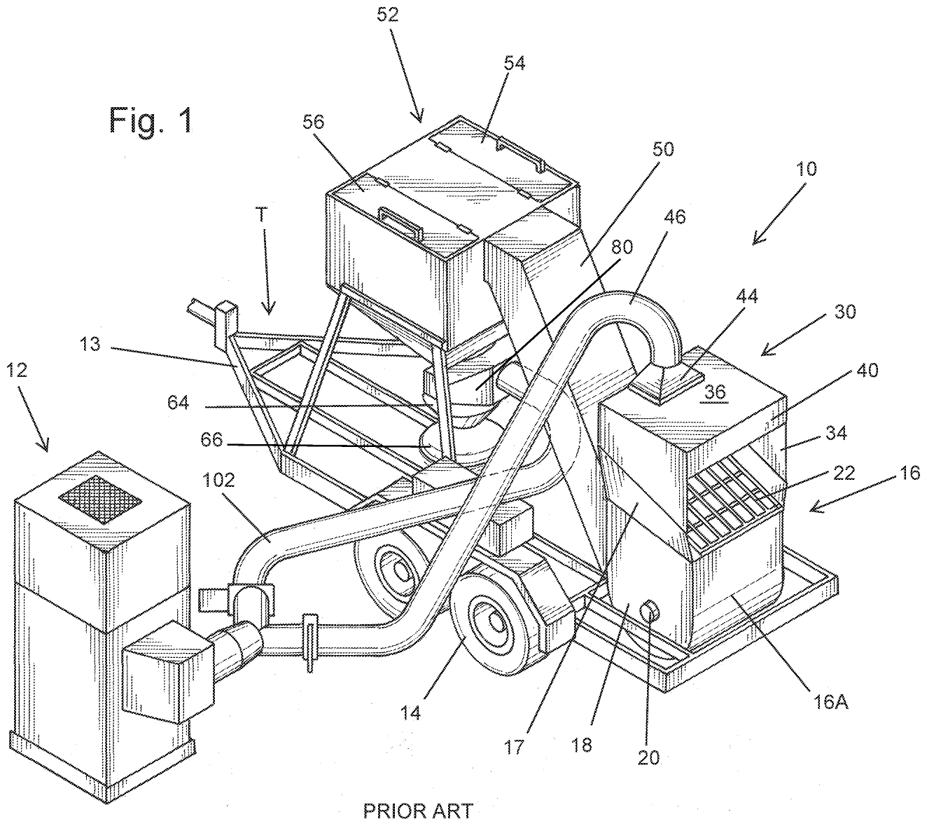

Referring first to FIG. 1, there is shown an embodiment from U.S. Pat. No. 10,946,553, incorporated herein by reference for all purposes. FIG. 1 depicts a gunite rig 10 equipped with a dust mitigation system. The mitigation system shown in FIG. 1 comprises a trailered gunite rig, shown generally as 10, which is connected by hoses, described more fully hereafter, to a dust collection unit shown generally as 12. Gunite/shortcrete trailer rigs and their operation are well known to those skilled in the art. For example, gunite rigs marketed by Allentown Shotcrete Technology, Inc., a Putzmeister Company, are widely used around the world, their operation being well understood in the application of refractory linings to vessels and similar applications.

Gunite rig 10 comprises a trailer, shown generally as T, comprising a frame 13 to which are connected wheels 14. Accordingly, the unit is portable and can be moved from location to location as needed. Mounted on trailer 10 is a gunite mixer of a type well known to those skilled in the art. Mixer 16 comprises a box-like structure 18 in which are mounted paddles (not shown) rotatably mounted on a driven axle 20. Mixer 16 has a grate 22 which can be provided with serrated blades or the like (not shown) for a purpose hereinafter described. Mounted on mixer 16 is a hood shown generally as 30 which comprises first and second spaced side walls 32 and 34, respectively, a top wall 36, and a back wall (not shown). Parapet wall 17 extends upwardly from mixer 16. A lip 40 extends downwardly from the front edge of top wall 36, the lip 40 together with side walls 32 and 34 defining an opening into the mixer 16 above the grate 22. A vent 44 is connected to the top wall 36 of hood 30, vent 44 in turn being connected by a hose 46 by suitable plumbing and connections to dust collector 12 which provides a vacuum and filter system.

As is well known to those skilled in the art, bags of gunite material which frequently contains silica in some particulate form, are placed on the grate 22 where the serrated blade or cutter referred to above rips them open, the gunite material falling into the lower, mixing section 16A of mixer 16 where it is wetted with water and mixed using the paddle mixer noted above. In this operation of opening the bags by ripping them with a cutter or the like, significant amounts of gunite dust, e.g., silica, become airborne and can escape into the atmosphere. In this step, silica dust generation is substantially eliminated by use of a first dust mitigation system comprising hood 16, the hose 40, and dust collector 12. In this regard, the dust collector 12 provides a source of suction/vacuum such that dust or airborne material generated when the bags are opened on grate 22 is prevented from migrating into the surroundings by hood 30 in combination with the suction provided by dust collector 12 which effectively draws dust generated as the bags are opened through vent 44 and hose 46 to dust collector 12 where the dust is filtered out and substantially dust-free air is released.

As noted above, in mixer 16 the gunite material is wetted and mixed. The wetted gunite is transferred via a conveyor 50 to a hopper 52 having top doors 54 and 56. Hopper 52 has a bottom opening (not shown) which, when in the open position, allows a desired amount of wetted gunite material to fall downwardly through a funnel-shaped mouth 64 formed on top of a pot 66 which in turn is in selectively open communication with a sump 68. The sump is connected to a transfer hose (not shown) which in turn is connected to a gunite nozzle (not shown) in a well-known manner.

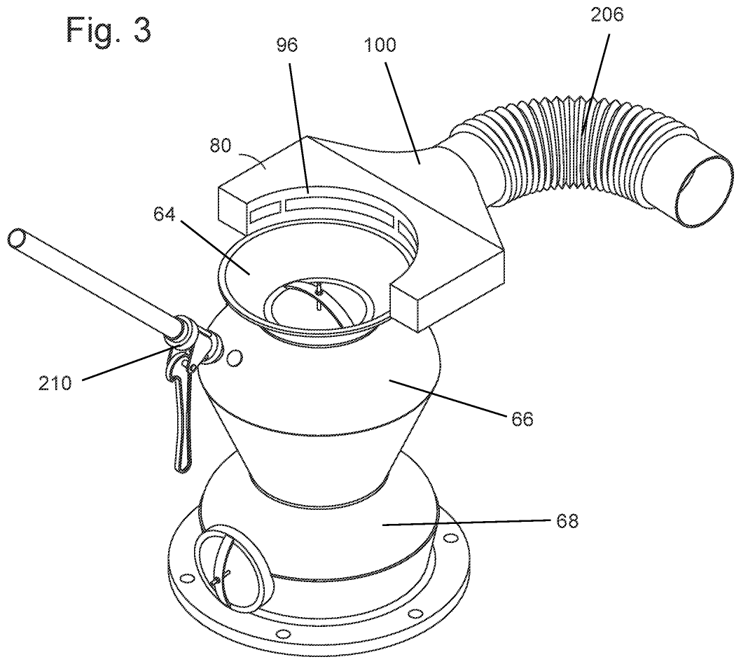

With reference to FIGS. 1 and 3, and as noted above, bottom opening (not shown) of hopper 52 is opened, gunite falls into funnel-shaped mouth 64 and since the gunite is merely wetted as opposed to being a slurry, a significant amount of airborne dust (silica) is generated in the space between hopper 52 and pot 66. Left unchecked, this dust escapes into the temporary enclosure in which the gunite rig is positioned. As noted, this creates hazardous conditions for workers, the dangers of silica dust being well known. To alleviate and substantially eliminate this dust from becoming airborne in the air surrounding the gunite rig, a plenum box 80 is positioned in at least partial surrounding relationship to funnel-shaped mouth 64. There is a front wall 96 in plenum 80 which is generally arcuate having substantially the same radius of curvature as funnel-shaped mouth 64. As also can be seen particularly with reference to FIG. 3, front wall 96 is comprised of a screened intake which communicates with the interior of plenum box 80. Plenum box 80 at its rear end has a vent 100. In the embodiment of FIG. 1, plenum 80 is connected to a hose 102, which in turn is connected by fittings to dust collector 12. Accordingly, when hopper gates 60 and 62 are opened, the wetted gunite material falls into pot 66, the dust which is generated being drawn in through the screened openings in front wall 96 of plenum box 80 and transferred via hose 102 to the dust collection apparatus 12. Thus, plenum box 80, vent 100, hose 102 and dust collection apparatus 12 comprise a second dust mitigation system.

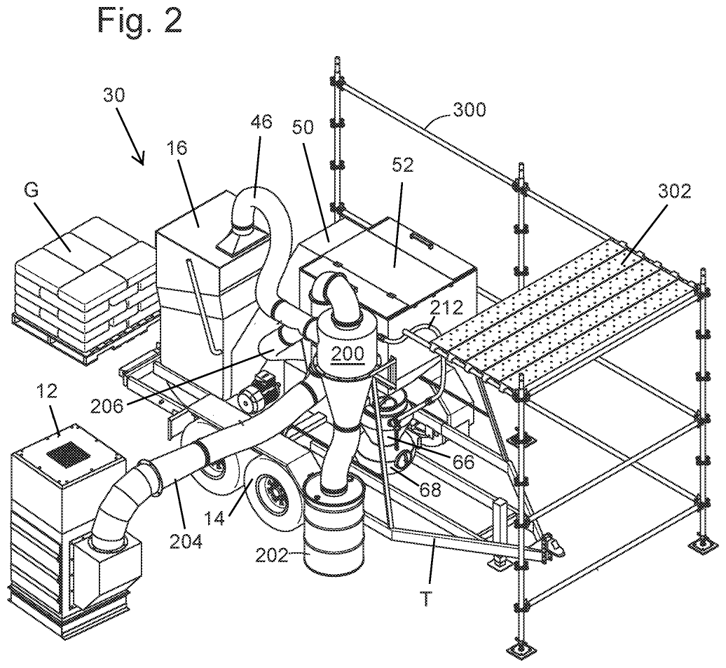

The present invention provides improvements over the prior art design. The gunite rig of FIG. 2 is shown from a slightly different perspective as that of FIG. 1, but those components which are the same in FIGS. 1 and 2 will have the same reference characters.

Depicted in FIG. 2 is a gunite rig shown generally as 30. As in FIG. 1, the system of FIG. 2 includes dust collection unit 12, mixer 16, hose 46, conveyor 50, and hopper 52. The components all function in the same way as in the system of FIG. 1. Sacks of gunite G are emptied into mixer 16 wherein the gunite is wetted, carried into hopper 52, and dumped into pot 66. Dust is removed from mixer 16 by hood 30 and during the dumping stage by plenum 80. One of the newly added features of FIG. 2 is a separator 200. Separator 200 can be of various types well known to those skilled in the art but preferably is a cyclone separator. Separator 200 is disposed between mixer 16 and dust collection apparatus 12. Thus, dust which is collected from mixer 16 by hood 30 is transferred via hose 46 to separator 200. The dust collected through plenum 80 is also transferred to separator 200 via hose 206. Inside separator 200 the heavier particles are separated out and fall to disposal container/drum 202 and the lighter particles are pulled by vacuum through hose 204 to dust collection apparatus 12. The addition of separator 200 to the gunite rig improves the operation of the system by ensuring larger particles do not clog the filters in the dust collection system. It will be appreciated that dust collection apparatus 12 can act as the sole vacuum source for the system of the present invention. Alternatively, multiple vacuum sources and/or dust collection apparatuses can be used.

Another improvement to the system can best be seen with reference to FIG. 3, wherein it can be seen that pot 66 has a pop-off valve 210. Pop-off valve 210 is connected by hose 212 to separator 200. As is well known to those skilled in the art, when the gunite is being used to form a refractory surface on a vessel wall, the pot 66 and sump 68 are pressurized. To de-pressurize pot 66, the pressurized air is released. Pop-off valve 210 allows for an additional safety measure during the pressurization and depressurization of pot 66. If the pressure is too much, pop-off valve 210 will automatically open, and any gunite particles will be taken through hose 212 to separator 200.

For particularly sensitive environments, if further dust mitigation is desired, scaffolding 300 can be erected and covered in plastic strips 302 or the like.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A system for capturing airborne particles from a gunite preparation apparatus, said apparatus comprising a mixer for mixing the gunite ingredients to form a gunite end product, a transfer system for moving the gunite end product to a hopper, a pot positioned below said hopper and having an axially upwardly facing mouth for receiving gunite product from said hopper, said system further comprising:
a vent hood positioned over said mixer;
a first conveying hose having a first end connected to said vent hood and a second end connected to a separator;
a second conveying hose having a first end connected to said separator and a second end connected to a vacuum source;
a plenum box positioned adjacent the mouth of said pot and partially surrounding said mouth; and
a third conveying hose having a first end connected to said plenum box and a second end connected to said separator.

2. The system of claim 1, wherein said separator comprises a cyclone separator.

3. The system of claim 1, wherein said separator is connected to a disposal container, whereby heavier particles fall into said disposal container and lighter particles are carried by said second conveying hose to said vacuum source.

4. The system of claim 1, wherein said vacuum source comprises a dust collecting apparatus.

5. The system of claim 4, wherein said dust collecting apparatus comprises a filtering system.

6. The system of claim 1, further comprising:
a pop-off valve connected to said pot; and
a fourth conveying hose having one end connected to said pop-off valve and said second end connected to said separator.
